(19) United States
(12) Patent Application Publication
(10) Pub. No.: US 2024/0408509 A1
(43) Pub. Date: Dec. 12, 2024

(54) CUSTOMIZED AVATARS FOR USE WITH NON-FUNGIBLE TOKENS

(71) Applicant: Universal City Studios LLC, Universal City, CA (US)

(72) Inventors: Angelo Pagliuca, Orlando, FL (US); Josiah Logan Bender, Winter Park, FL (US); Anthony Melo, Orlando, FL (US); Robert Anthony Rodriguez, Los Angeles, CA (US)

(21) Appl. No.: 18/735,894

(22) Filed: Jun. 6, 2024

Related U.S. Application Data
(60) Provisional application No. 63/472,502, filed on Jun. 12, 2023.

(51) Int. Cl. A63J 5/02; A63G 31/16; G06Q 20/36

(52) U.S. Cl. CPC A63J 5/02; G06Q 20/367; A63G 31/16

(57) ABSTRACT

A customizable avatar system for an amusement park attraction includes one or more processors configured to identify a non-fungible token (NFT) associated with a user within the amusement park attraction. Additionally, the one or more processors are configured to adapt a virtual feature based on the NFT for integration with a displayed avatar. The system also includes a display configured to display the avatar integrated with the virtual feature.

### CROSS-REFERENCE TO RELATED APPLICATION

This application claims priority to and benefit of U.S. Provisional Application No. 63/472,502, entitled “CUSTOMIZED AVATARS FOR USE WITH NON-FUNGIBLE TOKENS,” filed Jun. 12, 2023, which is hereby incorporated by reference in its entirety for all purposes.

### BACKGROUND

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Amusement parks may include various entertainment attractions. Some entertainment attractions may enable guests to view an animated character via a display system. In addition, these animated characters may be visible as part of attraction theming, shows, souvenirs, etc. Thus, to provide a more immersive experience, guests may wish to interact with these animated characters.

### BRIEF DESCRIPTION

Certain embodiments commensurate in scope with the originally claimed subject matter are discussed below. These embodiments are not intended to limit the scope of the disclosure. Indeed, the present disclosure may encompass a variety of forms that may be similar to or different from the embodiments set forth below.

In an embodiment, a customizable avatar system for an amusement park attraction includes one or more processors configured to identify a non-fungible token (NFT) associated with a user within the amusement park attraction. Additionally, the one or more processors are configured to adapt a virtual feature based on the NFT for integration with a displayed avatar. The system also includes a display configured to display the avatar integrated with the virtual feature.

In an embodiment, a customizable avatar system for an amusement park attraction includes one or more processors configured to identify a non-fungible token (NFT) associated with a user within the amusement park attraction. Additionally, the one or more processors are configured to adapt a virtual feature based on the NFT for integration with a displayed avatar. Furthermore, the one or more processors are configured to instruct a display to display the avatar integrated with the virtual feature.

In an embodiment, a method of operating a display system for one or more amusement park attractions includes identifying, using one or more processors, a non-fungible token (NFT) associated with a user within the amusement park attraction. The method further includes adapting, using the one or more processors, a virtual feature based on the NFT for integration with a displayed avatar. Additionally, the method includes displaying, using a display, the avatar integrated with the virtual feature.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram of an amusement park attraction showing customizable avatars associated with non-fungible tokens (NFTs), in accordance with an aspect of the present disclosure;

FIG. 2 is an example of a user device displaying a customizable avatar, in accordance with an aspect of the present disclosure;

FIG. 3 is a schematic diagram of a customizable avatar workflow, in accordance with an aspect of the present disclosure;

FIG. 4 is an example of graphical user interface (GUI) on a display screen of a user device for use with the customizable avatar system, in accordance with an aspect of the present disclosure;

FIG. 5 is a flow diagram of a method for generating and displaying customizable avatars associated with an NFT, in accordance with an aspect of the present disclosure;

FIG. 6 is a flow diagram of a method for generating and displaying customizable avatars associated with NFTs, in accordance with an aspect of the present disclosure;

FIG. 7 is a flow diagram of a method for displaying NFTs based on viewing permissions, in accordance with an aspect of the present disclosure; and

FIG. 8 is an example of a marketplace GUI for trading NFTs, in accordance with an aspect of the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. One or more specific embodiments of the present embodiments described herein will be described below. In an effort to provide a concise description of these embodiments, all features of an actual implementation may not be described in the specification. It should be noted that in the development of any such actual implementation, as in any engineering or design project, numerous implementation-specific decisions must be made to achieve the developers' specific goals, such as compliance with system-related and business-related constraints, which may vary from one implementation to another. Moreover, it should be noted that such a development effort might be complex and time consuming, but would nevertheless be a routine undertaking of design, fabrication, and manufacture for those of ordinary skill having the benefit of this disclosure.

Amusement parks may provide viewable media as part of an immersive environment for guests (e.g., users, viewers, audience). The viewable media may include virtual features presented using display systems (e.g., display devices, projectors, holograms, heads-up or head-mounted displays, and the like). For example, the virtual features may include animated characters that move and behave in a preconfigured or controllable manner. However, the viewable media may feel unengaging for guests who have limited personal investment in the virtual features.

Accordingly, the present embodiments relate generally to systems and methods that utilize digital objects or tokens, such as non-fungible token (NFTs), to enhance an experience for users in the immersive environment. An NFT may refer to unit of data that may be stored in a distributed ledger (e.g., blockchain). In an embodiment, the unit of data may link to or be associated with digital assets, such as image or video data, text data, model data, audio data, etc., and these digital assets may be stored off-chain. The NFT is unique and/or non-interchangeable, such that a unique identity and ownership can be confirmed (e.g., verified). This may impart a feeling of ownership over the NFT in a manner that is similar to a feeling of ownership over a physical object (e.g., physical photograph or a collectable toy). However, unlike the physical object, the NFT may not be lost, broken, and/or cumbersome to carry. Indeed, one or more NFTs (e.g., any number of NFTs, such as 1, 2, 3, 4, 5, more than 10, more than 100) may be stored in a distributed ledger and accessible from a digital wallet of the user. The NFT may also have other advantages (e.g., as compared to the physical object), such as that the NFT may also be easily transferred to other users (e.g., via a digital marketplace; without meeting in person).

In an embodiment, the systems and methods create virtual features based on the NFTs (e.g., transform the NFTs or their associated information into virtual features) to enhance the experience for the users in the viewable environment. For example, the NFTs may encompass various digital artworks and/or digital collectible items, such as an image (e.g., an NFT image) or software-generated model of an accessory (e.g., hat, cape, jewelry, toy, wand, tool, trail or cloud that represents a superpower) that can be used in an immersive environment, such as an amusement park. A control system (e.g., central control system, computing system) may detect that the user is in possession of the NFT that includes the image of the accessory. Then, the control system may create or retrieve a virtual feature (e.g., derivative feature; NFT-based feature; modified or transformed version) of the NFT. The virtual feature may be an image (e.g., a 3D image), model, mesh, sound, behavior, ability, visual filter, or other suitable adaptation to a portion of the viewable environment (e.g., an animated character). The virtual feature and the NFT may share one or more elements, such as a type (e.g., both are hats). However, the virtual feature and the NFT may also be different with respect to one or more elements, such as a color (e.g., one is blue, one is white).

An animated character displayed in the viewable environment may appear to adapt or interact with (e.g., wear, carry, assume) the virtual features. For example, if a user owns an NFT of a hat, the control system may generate a hat based on the NFT, and the animated character may wear the hat. In some embodiments, the animated character may be an avatar. The avatar, as provided herein, may be a displayed character that may be associated with the immersive environment and/or with the user. That is, the animated character may include metadata (e.g., identification number, username) that identifies the animated character as an avatar associated with (e.g., belonging to, representing) the immersive environment and/or with the user. In this way, the user may collect NFTs and see an avatar(s) customized with the virtual features displayed in the viewable environment. Because the virtual features are generated based on the NFTs, the user may feel a sense of ownership of the avatar based on exclusivity or uniqueness of the virtual features.

In one example, the avatar may be a well-known character within the immersive environment (e.g., a video game character). When the character is customized with virtual features provided by a particular user (e.g., a baseball hat of the user's favorite team), the user feels more connected to both the character and the immersive environment. In another example, the avatar may be an avatar representative of the user, and the avatar may be customized using NFTs associated with an experience of the immersive environment. For example, the avatar may wear a pin that says “I rode the Loop Coaster!” that was generated based on an NFT collected by the user after experiencing the ride. In other words, by personalizing the avatar with the virtual features, the user may experience entertainment from owning the NFTs.

Furthermore, the entertainment provided by the virtual features may motivate users to participate in activities that enable the users to buy, trade, earn, or otherwise acquire the NFTs. For example, the user may attain the NFTs from experiences outside the amusement park, such as a video game or a rewards program. Ownership of items in the video game or the rewards program may correspond to ownership of respective NFTs on the distributed ledger. As such, the user may maintain a collection of NFTs which can be brought (e.g., imported) to the amusement park and integrated with the user's experience at the amusement park.

Scarcity of the NFTs may drive a market in which users buy, sell, trade, or gift the NFTs. To this end, the amusement park may include kiosks (e.g., trading post, terminal) to facilitate such transactions within the amusement park. For example, a kiosk may include a computer connected to the distributed ledger and a display presenting a GUI. A first user (e.g., seller, first trader) may submit a first NFT or a first virtual feature associated the first NFT to the kiosk to be sold or traded. The kiosk may display the first virtual feature (e.g., an avatar wearing the virtual feature) and indicate its availability, price, description, and/or any relevant metadata. A second user (e.g., buyer, second trader), upon seeing the first virtual feature presented at the kiosk, may submit a bid to acquire the first NFT. The bid may be a trade of the first NFT for a second NFT owned by the second user, or the bid may be a monetary value (e.g., one dollar, two Bitcoin, three fungible tokens). Then, the kiosk may facilitate (e.g., broker) the transaction if the first user and the second user agree to the transaction. That is, the computer may transfer ownership of the first NFT and/or the second NFT between the first user and the second user.

In some embodiments, the animated character and the virtual features may be provided for public display on one or more public display devices. For example, the animated character may be displayed or projected on a screen that is visible to an audience of guests. Alternatively or additionally, the animated character and the virtual features may be provided for private display on one or more private display devices. For example, the viewable environment may be displayed on one or more personal display devices (e.g., mobile devices, head-mounted displays, etc.) of one or more users. Public or private display of the virtual features may be based on permissions associated with the NFTs. For example, the NFTs may include permissions to permit public display and/or permissions to permit private display. The user may configure these permissions to enable or disable certain display modes.

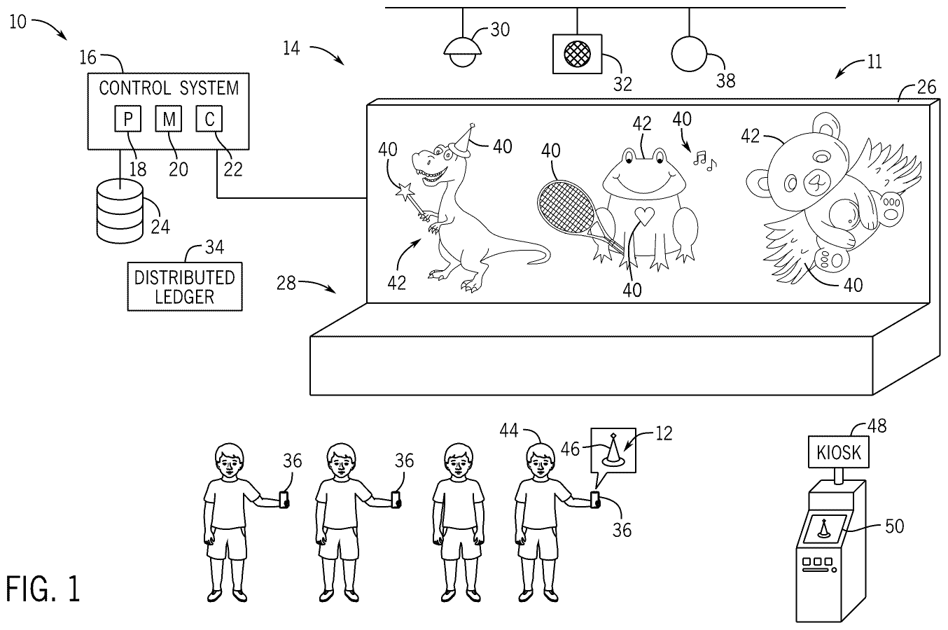

With the foregoing in mind, FIG. 1 is a schematic diagram of a viewing a customizable avatar system 10 that utilizes non-fungible tokens (NFTs) 12 within an amusement park attraction 14. As shown, the amusement park attraction 14 is a public display attraction configured to display images using a display system 11 to an audience of users. However, it should be appreciated that the customizable avatar system 10 may additionally or alternatively be implemented in any type of amusement park attraction, such as a ride attraction, a walk-through attraction, a conveyor attraction (e.g., with a conveyor to carry the one or more users) a motion simulator attraction (e.g., with a stationary ride vehicle to carry the one or more users), a recreational environment, a restaurant, a hotel, or the like.

The customizable avatar system 10 includes a control system 16 that includes a processor(s) 18, a memory device(s) 20, and a communication device(s) 22. The customizable avatar system 10 also includes one or more databases 24 that store data and one or more display devices 26 of the display system 11 that display images (e.g., animated characters). The one or more display devices 26 may be part of or coupled to a stage 28 that provides physical or aesthetic context for the displayed images. As shown, the display devices 26 are screens (e.g., projector screens, LCD displays, etc.) However, it should be appreciated that the display devices 26 may additionally or alternatively include any type of display system, such as a holographic projector, a Pepper's Ghost display system, a volumetric display, a stereoscopic display, For example, the stage 28 may be a runway for animated characters displayed on the display devices 26. The control system 16 may include or be communicatively coupled to the one or more databases 24, and the control system 16 may be communicatively coupled to the one or more display devices 26. The customizable avatar system 10 may also include one or more lights 30 to provide lighting effects and/or one or more speakers 32 to provide sound effects. Additional or other special effects (e.g., haptic effects, special effect materials) are also contemplated. The control system 16 may be communicatively coupled to the one or more lights 30 and/or to the one or more speakers 32. In another embodiment, the customizable avatar system 10 may include or be communicatively coupled to one or more private display devices (e.g., mobile devices, heads-up displays, head-mounted displays) configured to display the images for one or more permitted users.

At least some of the one or more users may possess one or more NFTs 12 which are stored in a distributed ledger 34 (e.g., blockchain) and are accessible via respective digital wallets of the one or more users. In an embodiment, an application (e.g., software application) on respective user devices 36 (e.g., mobile phone, tablet, watch, toy, wand, and/or band) may include the respective digital wallets of the one or more users. Then, when a particular user device 36 is in the amusement park attraction 14, the control system 16 may communicate (e.g., over a network, such as a wireless network) with the particular user device 36 to access the respective digital wallet and to identify that the user associated with the particular user device 36 possesses the one or more NFTs 12 in the respective digital wallet. Identification of the NFT 12 may permit the control system 16 to directly access the NFT-associated data. This data may be stored on the user device 36 of the user and/or may be stored in one or more accessible databases 24.

In an embodiment, the particular user device 36 may store (e.g., in a RFID tag) an address of the respective digital wallet, and then, the control system 16 may receive and utilize the address to access the respective digital wallet and to identify that the user associated with the particular user device 36 possesses the one or more NFTs 12 in the respective digital wallet. In an embodiment, one or more sensors 38 may collect sensor data and provide the sensor data to the control system 16. Then, the control system 16 may process the sensor data to identify respective user profiles (e.g., user accounts) associated with the one or more users. Each of the user profiles may include respective park visit history, transaction history, achievements and scores, an address for a digital wallet, and the like. Then, the control system 16 may utilize the address for the digital wallet to access the respective digital wallet and to identify that the user possesses the one or more NFTs 12 in the respective digital wallet. In such cases, the one or more sensors 38 may be cameras, facial recognition cameras, motion characteristic sensors, identity sensors, or the like. The one or more sensors 38 may detect one or more identifying characteristics of the user, such as body temperature, gait, posture, facial structure, skeletal structure, speech, or the like. The one or more sensors 38 may capture image(s) of the user(s), which may then be used to displayed for visualization by the user(s). The one or more sensors 38 may be installed at various locations in the amusement park attraction 14.

Regardless of the techniques used to identify that the one or more users possess the one or more NFTs, the customizable avatar system 10 may use the one or more NFTs 12 to provide entertainment to the one or more users while the one or more users are within the amusement park attraction 14. In some embodiments, the customizable avatar system 10 may not be configured to display the NFTs 12 directly. For example, the NFTs may be in a format that is not suitable for integration with the customizable avatar system 10 or elements (e.g., animated characters 42) therein. Instead, the control system 16 may instruct the display device 26 to display one or more virtual features 40 associated with the one or more NFTs 12. For example, an NFT 12 associated with a user (e.g., in the user's digital wallet) may include or refer to NFT-associated data (e.g., image or video data, text data, model data, audio data, etc.) associated with a digital item (e.g., an accessory), a trait (e.g., a color), an action (e.g., a cartwheel), or another feature. Then, the control system 16 may generate a virtual feature 40 based on the NFT 12 (e.g., based on the NFT-associated data). For example, the virtual feature 40 may be an adaptation (e.g., derivative) of the NFT 12 for display by the customizable avatar system 10. In this way, the NFT 12—or the concept behind the NFT 12—is made viewable via the display screen 26 as the virtual feature 40. To this end, the virtual feature 40 may be an image, model, mesh, sound, action, visual filter, or other suitable adaptation of the NFT 12 to be shown via the customizable avatar system 10. In some embodiments, the virtual feature 40 may be pre-generated and stored in the database 24 in association with the NFT 12, and the control system 16 may retrieve the virtual feature 40 from the database 24 in order to display the virtual feature 40.

In some embodiments, the one or more virtual features 40 may be integrated with one or more animated characters 42 (e.g., avatars), such that the display system 11 displays each of the animated characters 42 appearing to exhibit (e.g., wear, hold, interact with, or perform) one or more of the virtual features 40. The animated characters 42 may be avatars associated with respective users or different characters, and each avatar may exhibit the one or more virtual features 40 associated with the one or more NFTs 12 possessed by the respective user of the avatar. For example, the virtual feature 40 may be a mesh generated based on the NFT 12 and adapted to visually integrate with (e.g., scale to) the animated character 42 acting as the avatar associated with the owner of the NFT 12. The mesh may be a 3D object, image, or model dynamically incorporated with the animated character 42. In an embodiment, the animated character 42 may have particular virtual features 40 that are available, such as a hat or a shirt. If the NFT 12 is used to customize the animated character 42, an image associated with the NFT 12 is used to generate the virtual feature 40. The virtual feature 40 may have rules-based scaling and placement relative to the animated character such that the image of the NFT 12 is appropriately scaled to fit on the shirt or hat. In this manner, the image of the NFT 12 may not necessarily be pre-rendered as part of the animation of the animated character 42. However, use of the customizable avatar system 10 may cause the image to be accessed by the control system 16 for integration with the display of the animated character 42. If the animated character 42 is uncustomized, its default animation may show a blank shirt or blank hat (or no hat).

In the illustrated embodiment, a first user 44 has a digital wallet containing an NFT 12 of a hat 46. Based on sensor data collected by the one or more sensors 38, the control system 16 may identify a user profile of the first user 44 and access the digital wallet via a digital wallet address provided by the user profile. Then, the control system 16 may generate or retrieve a first virtual feature 40 associated with the NFT 12 of the hat 46. In some embodiments, the first virtual feature 40 may be generated or retrieved in response to a request received from the user device 36 of the first user 44 to display the first virtual feature 40. The control system 16 may adapt the first virtual feature 40 for integration with a first animated character 42 associated with the first user 44. For example, the first virtual feature 40 may be a 3D model (e.g., mesh) of the hat 46 adapted to be worn by the first animated character 42. In addition to the first virtual feature 40, additional virtual features based on additional NFTs associated with the first user 44, such as a wand, may be adapted for integration with the first animated character 42. Similarly, a second animated character 42 may be associated with a second user, and the display system 11 may display the virtual features 40 associated with NFTs of the second user, such as a sweater and a squash racket, adapted for integration with the second animated character. As shown, the virtual features 40 may include an audio feature, which may cause the second animated character to sing a song, for example.

An amusement park may include one or more kiosks 48 distributed throughout a geographic area where users may buy, sell, and/or trade NFTs. Each kiosk 48 may include a kiosk display 50 configured to display a GUI for users to view available NFTs and offer their own NFTs. Additionally, the kiosk 48 may execute NFT transactions by writing to the distributed ledger 34. The control system 16 or another controller may communicate with the kiosks 48 via a network, such as a wireless network, to facilitate operation of an NFT marketplace within the amusement park.

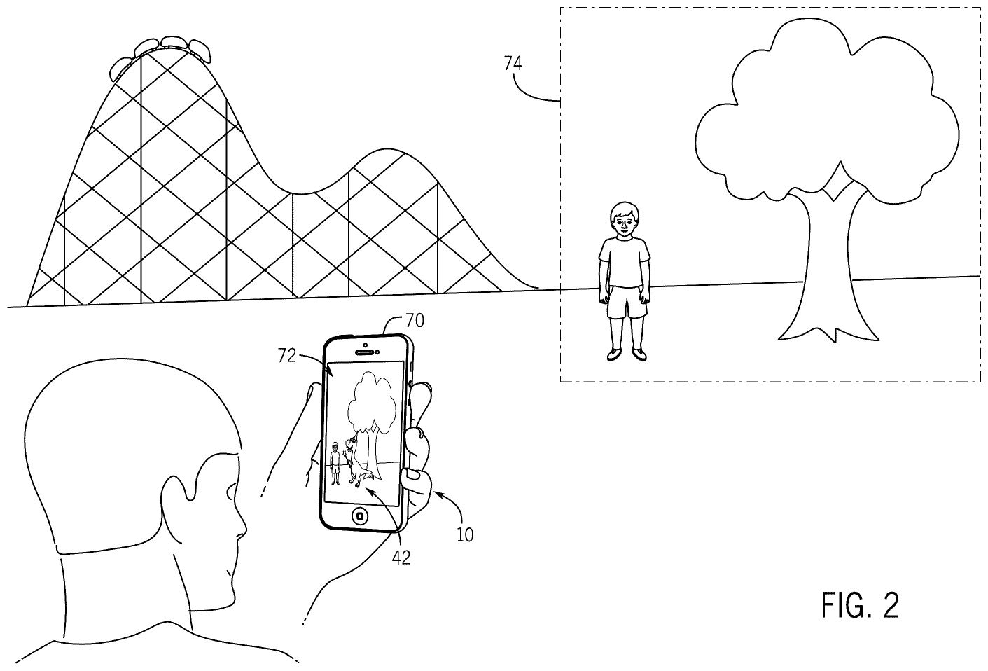

FIG. 2 illustrates an embodiment of the customizable avatar system 10 that provides a private viewing experience using a private display device 70. For example, the user device 36 may function as a private display device 70 that displays the animated characters 42 and the virtual features 40 associated with NFTs 12 owned by the user of the user device 36. The private display device 70 may provide an augmented reality (AR) experience by overlaying virtual images of the animated characters 42 over a camera view 72 of a real-world environment 74. Alternatively, the private display device 70 may include a wearable display, such as an augmented reality (AR) headset, a virtual reality (VR) headset, transparent displays, electronic glasses, and the like.

To augment the AR experience, the animated character 42 may be virtually mapped to geographic positions in the real-world environment 74. For example, the animated character 42 may be associated with a particular orientation and a particular geolocation determined by the control system 16 or a central controller. The control system 16 may determine (e.g., via GPS) a location and/or orientation of the private display device 70 and coordinate display of the animated character 42 to correspond to the virtual mapping. Thus, when viewed via the private display device 70, the animated character 42 may appear to be located in the particular orientation at the particular geolocation. The particular orientation and geolocation may be updated as the animated character 42 “moves.”

In the private viewing experience, the animated character 42 and virtual features 40 may be viewable to the user of the private display device in addition to or instead of being publicly displayed, such as shown in FIG. 1. Furthermore, the user's avatar may be viewable by other users via their private display devices. For example the other users may see the animated character 42 at the geographic position associated therewith. Additionally, the user may see other animated characters 42 sporting virtual features 40 belonging to the other users. In some embodiments, viewing permissions for the animated characters 42 may be restricted to exclude or include certain users or group of users. For example, the NFTs 12 (e.g., based on NFT-associated data, such as smart contracts or metadata) may include permissions to permit viewing by selected users (e.g., friends) associated with the user, and the user may adjust these permissions to control who sees the animated character 42.

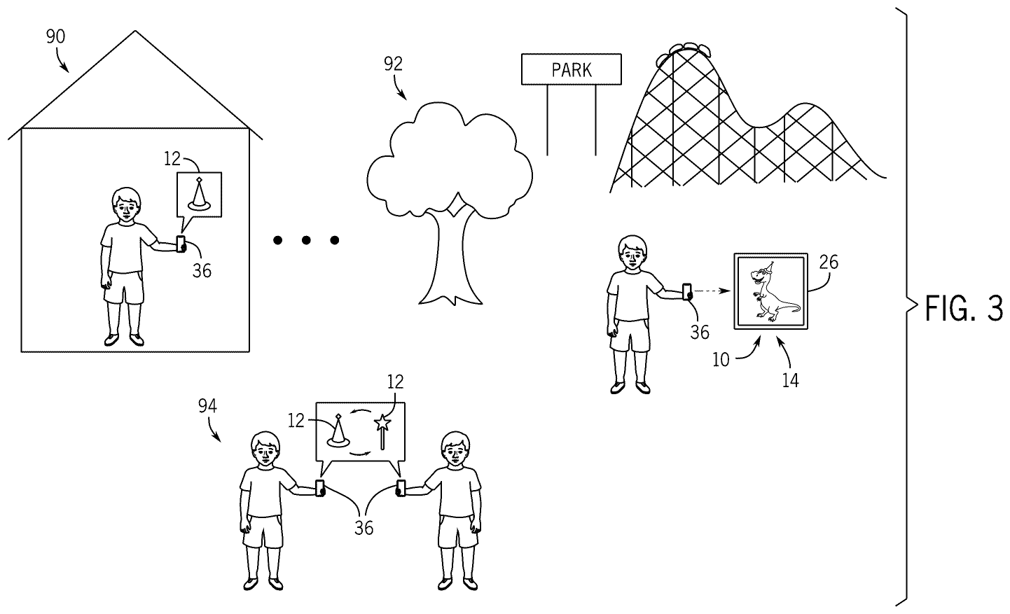

FIG. 3 illustrates a user experience in which the user may collect, view, and trade the NFTs 12. The user experience may include an at-home experience 90 (e.g., an experience outside the amusement park, an auxiliary environment), such as a video game or a rewards program, whereby the user may attain NFTs 12. For example, ownership of items in the video game or the rewards program may correspond to ownership of respective NFTs 12 on the distributed ledger 34 (see FIG. 1). Additionally, the at-home experience may include customizing one or more avatars with the items or attained NFTs 12. As such, the user may maintain a collection of NFTs 12 and/or avatars which can be brought (e.g., imported) to the amusement park and integrated with an in-park experience 92 (e.g., the amusement park attraction 14, an application on the user device 36).

In some embodiments, the items and/or avatar from the at-home experience 90 may be imported to the in-park experience 92 as the virtual features 40 or as the NFTs 12. For example, the items from the at-home experience 90 may be a 3D model integrated with avatar of the at-home experience 90. Then, the control system 16 may import the items, the avatar, or both for display in the in-park experience 92. In this way, the virtual features 40 may correspond directly to the items from the at-home experience 90.

The user experience may further include a trading aspect 94, which may be part of the at-home experience 90 and/or the in-park experience 92. In the trading aspect 94, the user may buy, sell, or trade NFTs 12 with other users via the user devices 36, as shown, or via the kiosks 48.

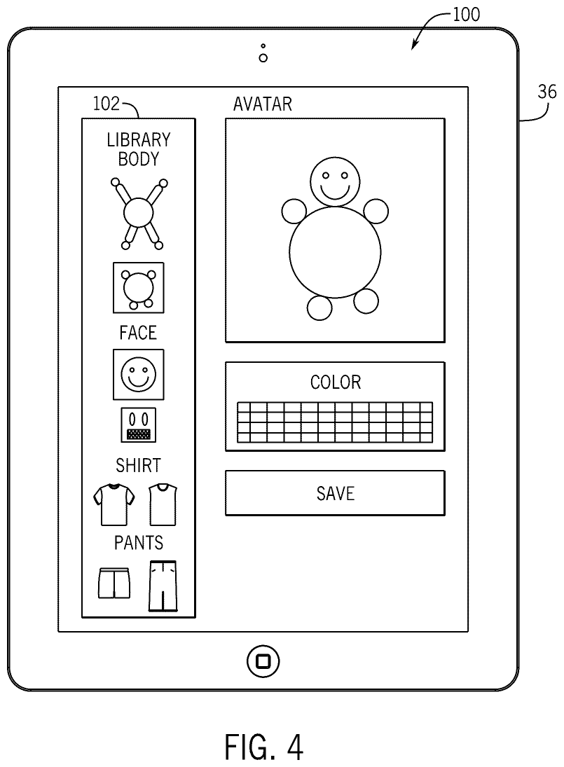

As noted herein, each user may be associated with one or more avatars (e.g., animated characters 42). In an embodiment, the user may provide inputs via an application (e.g., software application) on the user device 36 to create the one or more avatars. With the foregoing in mind, FIG. 4 illustrates an embodiment of an avatar creation graphical user interface (GUI) 100 that may be presented on a display screen, such as on the display screen of the user device 36. As shown, the avatar creation GUI 100 includes a library of available elements 102 (e.g., heads, bodies, body parts, clothing, accessories, colors, textures, letters, numbers; style guide) that may be used to create the one or more avatars. At least some of the elements 102 may correspond to the NFTs 12. In particular, the user may open the application to access the library of available elements 102, and then user may select from the library of available elements 102 to form a particular avatar. For example, the user may select a pink body, short blue hair, green eyes, and a blue dress to form the avatar. In an embodiment, the user may select objects (e.g., head, body, clothing) from the library of available elements 102, and also separately use a color palette or wheel to select a respective color for each object. The avatar creation GUI 100 may include the library of available elements 102, including the color palette or wheel. Additionally, the avatar creation GUI 100 may include a representation of the avatar, and the representation of the avatar may be updated in real-time (e.g., substantially real-time; following each selection of the element/object/color by the user) so that the user can visualize the avatar as the user builds the avatar with the application. In some embodiments, the avatar may be intended and/or designed to represent the user (e.g., each avatar represents a corresponding user/creator). The objects, colors, and representations of the avatar may correspond to respective NFTs 12 associated with the user. Additionally, once created, the avatar may be minted as an NFT. Thus, the avatar is composed of NFTs 12 and may itself be minted as an NFT.

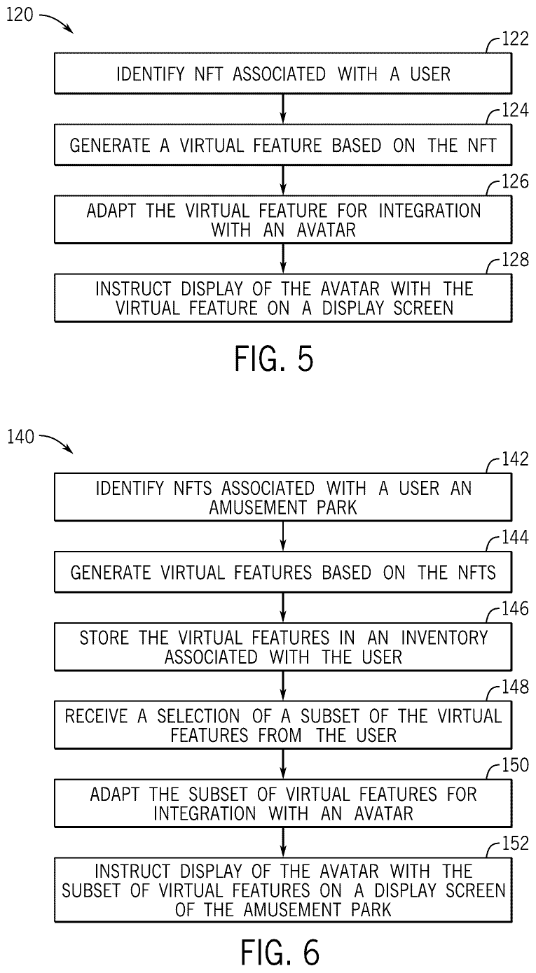

FIG. 5 is a flowchart of a method 120 for utilizing an NFT within the amusement park attraction 14, in accordance with an aspect of the present disclosure and with reference to features discussed in FIGS. 1-4. The method 120 includes various steps represented by blocks. It should be noted that the method 120 may be performed as an automated procedure by a control system, such as the control system 16 of FIG. 1. Although the flowchart illustrates the steps in a certain sequence, it should be understood that the steps may be performed in any suitable order and certain steps may be carried out simultaneously, where appropriate. Further, certain steps or portions of the method 120 may be performed by separate systems or devices.

At block 122, the control system 16 may identify an NFT 12 possessed by a user of an amusement park attraction. The NFT 12 may be stored in a distributed ledger 34 (e.g., blockchain) and is accessible via a digital wallet of the user. For example, an application (e.g., software application) on a user device 36 (e.g., mobile phone, tablet, watch, toy, wand, and/or band) associated with the user may include the digital wallet of the user. In an embodiment, when the user device is carried into the amusement park attraction, the control system may communicate (e.g., over a network, such as a wireless network) with the user device to access the digital wallet and to identify that the user associated with the user device possesses the NFT 12. The control system may utilize various other techniques to identify the NFT 12 possessed by the user of the amusement park attraction. For example, in some cases, the user may present a code (e.g., a QR code, a bar code, an alphanumeric code) to a scanner (e.g., imager or camera) of the kiosk 48 to enable the system to retrieve the digital wallet of the user.

The NFT 12 may link to or include data related to a feature to be displayed or presented by the display system 11. Such data may include image data, video data, audio data, text data, 3D model data, code, and the like. The NFT 12 may also include permissions configurable to enable public and/or private display of the NFT 12. That is, the user may choose to give the NFT 12 public permissions enabling the control system 16 to provide the NFT 12 to one or more public display devices. The user may also choose to give the NFT 12 private permissions enabling the control system 16 to provide the NFT 12 to one or more private display devices 70.

In some embodiments, the control system 16 may identify NFTs 12 that are registered with the amusement park attraction 14 as having a corresponding virtual feature. That is, the digital wallet of the user may include some NFTs that are compatible with the amusement park attraction 14 and other NFTs that are not compatible. For example, the control system 16 may identify NFTs in the digital wallet that are included in a list or database of compatible NFTs. In this way, each identified NFT may have a corresponding virtual feature 40.

At block 124, the control system 16 may generate a virtual feature 40 based on the NFT 12. The virtual feature 40 may be a 3D model or mesh of an object (e.g., an accessory), a programmed action (e.g., a cartwheel), a programmed attribute (e.g., color), audio (e.g., speech, sound effects, music), a visual filter (e.g., distortion), or other suitable feature that may be integrated with an animated character 42 and presented via the customizable avatar system 10.

In some embodiments, the virtual feature 40 may already be pre-generated and stored in the database 24 with metadata that associates the virtual feature 40 with the NFT 12. That is, the control system 16 may not generate the virtual feature 40. Instead, the control system 16 may reference the database 24 to select the virtual feature 40 associated with the NFT 12.

At block 126, the control system 16 may adapt the virtual feature 40 for integration with an animated character 42, such as the avatar of the user. The virtual feature 40 may be formatted to be compatible with integration with the animated character 42. For example, the virtual feature 40 may be a mesh that is dynamically incorporated into the model of the animated character 42. In this way, the virtual feature 40 may become part of the animated character 42.

At block 128, the control system 16 may instruct the one or more display devices 26 to display the animated character 42 with the virtual feature 40. The one or more display devices 26 may include a public display device as shown in FIG. 1 and/or a private display device(s) 70 as shown in FIG. 2. The NFT 12 or the avatar may include viewing permissions to regulate which display devices 26 are instructed to display the virtual feature 40. For example, the viewing permissions may enable other users (e.g., friends) associated with or near the user to view the animated character 42 with the virtual feature 40 via their private display devices 70.

FIG. 6 is a flowchart of a method 140 for utilizing NFTs within the amusement park attraction 14, in accordance with an aspect of the present disclosure and with reference to features discussed in FIGS. 1-4 . . . . The method 140 includes steps for generating, selecting, and displaying multiple virtual features 40 based on multiple NFTs associated with the user. It should be noted that the method 140 may be performed as an automated procedure by a control system, such as the control system 16 of FIG. 1. Although the flowchart illustrates the steps in a certain sequence, it should be understood that the steps may be performed in any suitable order and certain steps may be carried out simultaneously, where appropriate. Further, certain steps or portions of the method 140 may be performed by separate systems or devices.

At block 142, the control system 16 may identify one or more NFTs 12 possessed by a user of an amusement park attraction. As discussed above, the NFTs 12 may be stored in the distributed ledger 34 and is accessible via the digital wallet of the user. The control system 16 may access the digital wallet and to identify that the user associated with the user device 36 possesses the one or more NFTs 12. For example, the user may present a code (e.g., a QR code, a bar code, an alphanumeric code) to a scanner (e.g., imager or camera) of the kiosk 48 to enable the system to retrieve the digital wallet of the user. At block 144, the control system 16 may generate or retrieve respective virtual features 40 based on each of the one or more NFTs 12.

At block 146, the control system 16 may store the virtual features 40 in an inventory (e.g., library, collection, database) associated with the user. The user may access the inventory via an application on the user device 36, such as the avatar creation GUI 100, to view the virtual features 40 or the corresponding NFTs 12. Additionally, the application may enable the user to select one or more of the virtual features 40 for display by the display system 11.

At block 148, the control system 16 may receive a selection of a subset of the virtual features 40 for integration with the animated character 42. For example, the user may provide user inputs to the avatar creation GUI 100 to select the subset of the virtual features 40 that they wish to be displayed by the display system 11. In some embodiments, selection of the application may not allow some virtual features 40 to be selected with other virtual features 40. For example, if the selected subset of virtual features 40 includes a first virtual feature (e.g., cowboy hat) that is mutually exclusive with a second virtual feature (e.g., space helmet), then the application may disable or reject the selection of the subset of virtual features 40.

At block 150, the control system 16 may adapt the subset of virtual features 40 for integration with the animated character 42 or avatar. For example, each virtual feature of the subset of virtual features 40 may be formatted to be compatible with integration with the animated character 42. In this way, the animated character 42 may exhibit the subset of virtual features 40 simultaneously. At block 152, the control system 16 may instruct the one or more display devices 26 to display the animated character 42 with the subset of virtual features 40.

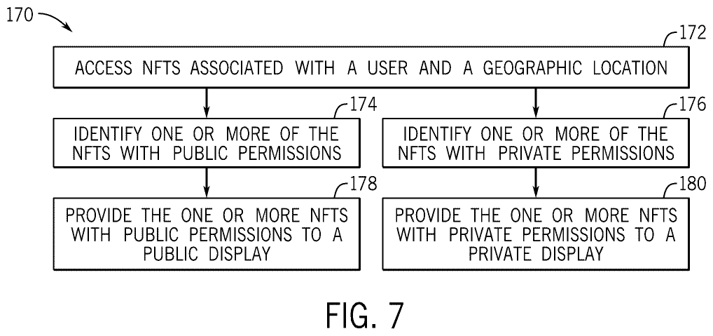

FIG. 7 is a flowchart of a method 170 for displaying animated characters 42 based on viewing permissions of the NFTs 12 and with reference to features discussed in FIGS. 1-4. It should be noted that the method 170 may be performed as an automated procedure by a control system, such as the control system 16 of FIG. 1. Although the flowchart illustrates the steps in a certain sequence, it should be understood that the steps may be performed in any suitable order and certain steps may be carried out simultaneously, where appropriate. Further, certain steps or portions of the method 170 may be performed by separate systems or devices.

At block 172, the control system 16 may access one or more NFTs 12 associated with the user. As discussed above, the NFTs 12 may be stored in the distributed ledger 34 and is accessible via the digital wallet of the user. The control system 16 may access the digital wallet and to identify that the user associated with the user device 36 possesses the one or more NFTs 12. For example, the user may present a code (e.g., a QR code, a bar code, an alphanumeric code) to a scanner (e.g., imager or camera) of the kiosk 48 to enable the system to retrieve the digital wallet of the user.

Each NFT 12 may include viewing permissions. For example, the NFT 12 may include metadata indicating whether the NFT 12 is intended for public display or for private display (e.g., via the private display device 70). Accordingly, the viewing permissions may include public permissions, private permissions, or both. At blocks 174 and 176, the control system 16 may identify one or more of the NFTs 12 with public permissions and one or more of the NFTs 12 with private permissions. At block 178, the control system 16 may provide the one or more NFTs 12 with public permissions to a public display device. Likewise, at block 180, the control system 16 may provide the one or more NFTs 12 with private permissions to a private display device. In some embodiments, the one or more NFTs 12 with public permissions may be provided to other private display devices. In this way, other users may view the one or more NFTs 12 via their private display devices if the one or more NFTs 12 include public permissions.

In some embodiments, the user may modify the viewing permissions to change who can see their avatar or NFTs 12. For example, the user may toggle the public permissions on and off. Additionally, the user may modify the private permissions to extend or restrict visibility of their NFTs 12 to individual users (e.g., “Mom”) or categories of users (e.g., friends).

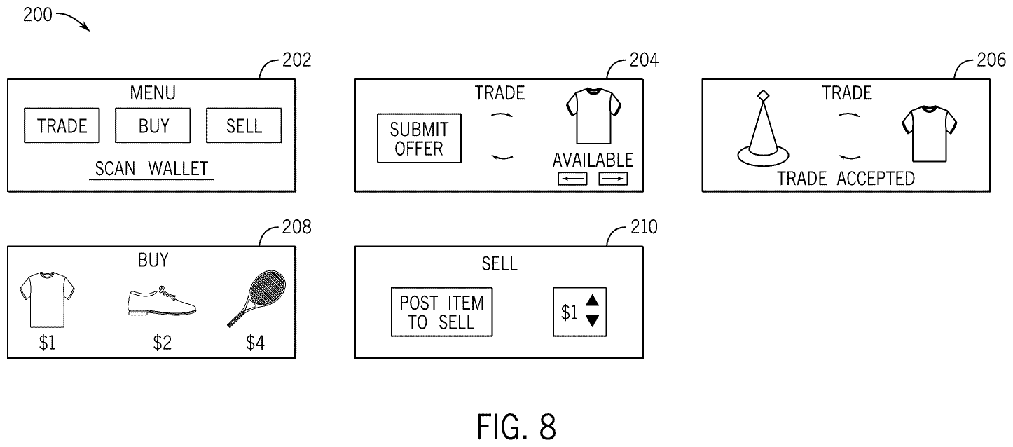

FIG. 8 illustrates an example of a marketplace GUI 200 that may be presented on the kiosk 48 or on an application of the user device 36. The marketplace GUI 200 includes functionality that enables users to trade, buy, and sell NFTs 12 between one another. The functionality may be distributed across pages 202, 204, 206, 208, and 210 of the marketplace GUI 200.

Page 202 is a menu that includes selectable options for the user to trade, buy, sell, or access their digital wallet. The marketplace GUI 200, upon receiving a user selection from these options, may direct to a different page. For example, if the user selects the trade option, the marketplace GUI 200 may direct to page 204.

Page 204 displays NFTs that are available for acquisition by trading. Users may browse the available NFTs and submit one or more of their own NFTs as an offer for one or more of the available NFTs. The available NFTs may have been posted by other users at the kiosk 48. For example, the kiosk 48 may receive a submission of a first NFT to be traded by a first user and display the first NFT on page 204 to solicit trade offers. Subsequently, the kiosk 48 may receive a trade offer from a second user, where by the second user offers to trade a second NFT in exchange for the first NFT. The kiosk 48, the control system 16, or a server may transmit a notification of the trade offer to the first user (e.g., via the application on the user device 36 of the first user) with options to accept or decline the trade offer. If the first user accepts the trade offer, then the marketplace GUI 200 may direct to page 206 to indicate the acceptance.

The marketplace GUI 200 may also include pages 208 and 210, where users may buy and sell NFTs, respectively. The NFTs may be bought from other users or from a dedicated seller. In some embodiments, NFTs may be sold via auction, whereby users may submit bids for the NFTs.

It should be appreciated that any features shown or described with reference to FIGS. 1-8 may be combined in any suitable manner. While only certain features of the present disclosure have been illustrated and described herein, many modifications and changes will occur to those skilled in the art. It is, therefore, to be understood that the appended claims are intended to cover all such modifications and changes as fall within the true spirit of the present disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. § 112(f). However, for any claims containing elements designated in any other manner, it is intended that such elements are not to be interpreted under 35 U.S.C. § 112(f).

1. A customizable avatar system for an amusement park attraction, the system comprising:
one or more processors configured to:
identify a non-fungible token (NFT) associated with a user within the amusement park attraction; and
adapt a virtual feature based on the NFT for integration with a displayed avatar; and
a display configured to display the avatar integrated with the virtual feature.

2. The system of claim 1, wherein the one or more processors is configured to identify the NFT associated with the user via communication with a user device carried by the user in the amusement park attraction.

3. The system of claim 1, wherein the NFT comprises NFT-associated data, and wherein the NFT-associated data comprises permissions to permit public display, and wherein the one or more processors are configured to cause display of the avatar on a public display.

4. The system of claim 1, wherein the NFT comprises NFT-associated data, and wherein the NFT-associated data comprises permissions to permit private display, and wherein the one or more processors are configured to cause display of the avatar on a private display.

5. The system of claim 1, wherein the one or more processors are configured to access a digital wallet of the user to identify the NFT.

6. The system of claim 1, wherein the virtual feature is a digital item, and wherein the display is configured to display the avatar holding, wearing, or interacting with the digital item.

7. The system of claim 1, wherein the NFT is associated with ownership of a digital item in an experience outside the amusement park attraction.

8. The system of claim 1, wherein the one or more processors are configured to:
receive a user selection of the virtual feature to be integrated with the avatar; and
adapt the virtual feature for integration with the avatar in response to the user selection.

9. The system of claim 1, wherein the display comprises a plurality of private displays, wherein each private display of the plurality of private displays is configured to display the avatar integrated with the virtual feature.

10. The system of claim 1, wherein the display is an augmented reality (AR) display.

11. A customizable avatar system for an amusement park attraction, the system comprising:
one or more processors configured to:
identify a non-fungible token (NFT) associated with a user within the amusement park attraction;
adapt a virtual feature based on the NET for integration with a displayed avatar; and
instruct a display to display the avatar integrated with the virtual feature.

12. A method of operating a display system for one or more amusement park attractions, the method comprising:
identifying, using one or more processors, a non-fungible token (NFT) associated with a user within the amusement park attraction;
adapting, using the one or more processors, a virtual feature based on the NFT for integration with a displayed avatar; and
displaying, using a display, the avatar integrated with the virtual feature.

13. The method of claim 12, comprising identifying the NFT associated with the user via communication with a user device carried by the user in the one or more amusement park attractions.

14. The method of claim 12, wherein the NFT comprises NFT-associated data, and wherein the NFT-associated data comprises permissions to permit public display, and wherein the method comprises displaying the avatar on a public display.

15. The method of claim 12, wherein the NFT comprises NFT-associated data, and wherein the NFT-associated data comprises permissions to permit private display, and wherein the method comprises displaying the avatar on a private display.

16. The method of claim 12, comprising displaying the avatar holding, wearing, or interacting with the virtual feature.

17. The method of claim 12, wherein the NFT is associated with ownership of a digital item in an auxiliary environment of the one or more amusement park attractions, and wherein the method comprises importing, using the one or more processors, the digital item from the auxiliary environment.

18. The method of claim 12, comprising:
receiving a user selection of the virtual feature to be integrated with the avatar; and
adapting the virtual feature for integration with the avatar in response to the user selection.

19. The method of claim 12, wherein the display is an augmented reality (AR) display.

20. The method of claim 12, wherein the display is a holographic display or a Pepper's ghost system.
